(19) United States
(12) Patent Application Publication
(10) Pub. No.: US 2004/0146272 A1
(43) Pub. Date: Jul. 29, 2004

(54) System and method for managing video evidence

(76) Inventors: Kurt A. Kessel, Altamonte Springs, FL (US); Robert D. McDonald, Great Falls, VA (US); Chris Kadoch, Leesburg, VA (US)

Correspondence Address: Rick A. Toering, Mintz Levin Cohn Ferris Glovsky and Popeo PC, Suite 900, 12010 Sunset Hills Road, Reston, VA, 20190, US

(21) Appl. No.: 10/753,563

(22) Filed: Jan. 9, 2004

Related U.S. Application Data
(60) Provisional application No. 60/438,759, filed on Jan. 9, 2003.

(51) Int. Cl. H04N 5/783

(52) U.S. Cl. 386/46; 386/69

(57) ABSTRACT

A system and method is disclosed for accepting, storing, retrieving, manipulating, and otherwise managing video images having potential evidentiary significance. A video image intake station collects surveillance, crime scene, police traffic stop, or other video images captured by a video image capture device and generates individual video image files. Each of the generated images files are uploaded to a server, and indexed and stored in a searchable database. For redundancy, a back-up copy of each image file is made and stored in an archive. Once image files have been placed in a searchable database, individual image files may be searched and accessed by users who have been granted appropriate access rights by an administrator. Users with an appropriate level of access rights can download an image file, have an image file e-mailed to an Internet address, or output an image file in any known or suitable output format (e.g., to a CD-ROM, DVD, floppy disk, or other media) for further processing or analysis. These image files may comprise original, un-edited image files, and/or redacted or edited image files depending on their relevancy and/or admissibility in a legal proceeding.

### RELATED APPLICATIONS

This Applications claims the benefit of the filing date of U.S. Provisional Patent Application No. 60/438,759, entitled “System and Method for Managing Video Evidence,” filed Jan. 9, 2003, which is hereby incorporated by reference in its entirety.

### FIELD OF THE INVENTION

The invention relates generally to videography, and more particularly to a system and method for accepting, storing, retrieving, manipulating, and otherwise managing video images having potential evidentiary significance.

### BACKGROUND OF THE INVENTION

Conventional video cameras capture video images and store them in either an analog or digital format on a given medium. This medium may comprise magnetic tape, a magnetic disk, an optical disk, a computer memory, or any other known medium for storing and/or recording video images.

As used herein, a video image may be defined as a recording of a scene over a period of time. A video image may be distinguished from a still image in that a video image captures and records continuous changes in the scene over the period of time whereas the still image captures the scene at one instant in time. A video image may also include audio information which may be contemporaneous with the scene.

In many instances, conventional video cameras are being used routinely to capture video images that may have subsequent evidentiary significance in a legal proceeding. For example, many local and state police organizations outfit their police vehicles with on-board video cameras to record traffic stops. Video images collected during such stops may prove invaluable in a plurality of different situations, such as where field sobriety tests are administered and the results are later questioned, or when motorists allege harassment or misconduct on the part of a police officer or officers during a stop.

In addition to law enforcement, it is not uncommon for banks, casinos, convenience stores, retail establishments, and other institutions to utilize video cameras for surveillance purposes in the hope that the perpetrator of a crime may be recorded while committing the crime.

One drawback associated with the acquisition of video images in these and other examples lies in the formidable task of managing the video images once they have been collected, as well as the individual media on which they are stored.

Consider, as an exemplary illustration, current evidence management systems utilized by law enforcement agencies to organize and store video images captured by police vehicle video cameras. At the conclusion of each police officer's shift, or at another predetermined interval, captured video images are typically transferred from a storage medium associated with the video cameras to another storage medium and/or storage facility. Oftentimes, this process is undertaken by a single individual, without the benefit of automation, and may be quite time-consuming given the large volume of video images to be transferred from each individual video camera. The process may be further lengthened when the medium in which the video images are initially captured differs from the storage medium.

One of the most common storage mediums currently utilized by law enforcement agencies is magnetic tape (e.g., VHS tape, beta tape, 8 mm tape, etc.). Once video images have been transferred to magnetic tape, for example, the contents of the tape may be indexed, and the tape itself may be logged-in to a police evidence facility, where it may reside on a shelf until it is needed.

One disadvantage associated with this practice lies in the inherent physical limitations of magnetic tape as a storage medium. For example, each time some forms of magnetic tape are played, the audio and video signals disposed thereon degrade. Some types of tape are also prone to tape stretch and wrinkle, and may be negatively impacted by exposure to certain environmental elements such as, for instance, heat.

These and other physical drawbacks associated with magnetic tape may be further accentuated when a selected segment of video images must be retrieved from a magnetic tape for use in a legal proceeding. Generally, video images are made available to both the prosecution and defense counsel prior to their presentation in Court. In situations where a police officer may be called as a witness, the officer may wish to review the captured video images prior to his or her testimony. It is also not uncommon for a Judge, magistrate, or other Court officer to request copies of the video images when called upon to rule on their admissibility in, for example, a preliminary hearing.

In some instances, law enforcement agencies have a designated employee to make copies of video images for each individual authorized to receive a copy (e.g., attorneys, court officers, witnesses). This may be a tedious and time-consuming process that typically requires the use of a video player and a video recorder that support the medium on which the video images are captured.

In other instances, law enforcement agencies may enable authorized individuals to check-out their only copy of video images for analysis. One disadvantage associated with this approach, however, is the potential for the loss, destruction, or alteration of the video images, either innocently or intentionally. This may be an unnecessarily risky proposition as the loss of valuable evidence can certainly have a dramatic impact on either (or both) of the litigants in a particular case. To protect against such incidents, increased security measures (e.g., encoding video images) may be taken, but are typically done so at an increased cost to the law enforcement agency.

Additional drawbacks exist. For example, the tedious process of copying video images may be further complicated when a Judge, magistrate, or other Court officer makes a determination that certain portions of the video images should be redacted before being viewed by a jury. The subsequent editing process may be lengthy and time-consuming, thus potentially holding up a Court proceeding.

These and other drawbacks exist with current law enforcement video data management systems.

### SUMMARY OF THE INVENTION

The invention solving these and other problems relates to a system and method for accepting, storing, retrieving, manipulating, and otherwise managing video images having potential evidentiary significance.

According to an embodiment of the invention, a video image intake station may collect (or intake/ingest) video images captured by a video image capture device. Examples of video images that may be captured may include, but are not limited to, video images of (or relating to) a bank, casino, convenience store, retail establishment, hospital, personal residence, housing complex, highway system, public bus, subway system, personal residence, medical treatment room or facility (e.g., operating room), court room, or crime scene. Additionally, the video images may comprise images captured by a video image capture device utilized by law enforcement officials, including those mounted in a law enforcement vehicle.

According to an embodiment of the invention, the video image intake station may comprise hardware and/or software to process the video images regardless of the format (or recording medium) of the video image capture device used to capture the video images. In addition to accepting video images in a plurality of formats, the video image intake station may further process the video images to create individual video image files. This process may be employed to select sequences of video images for indexing, archiving, and potential presentation. As an illustrative example, a video image capture device mounted in a police vehicle may record video images to a VHS tape during a particular time interval. During this time interval, several traffic stops or other incidents/events may be recorded. Such incidents may be recorded at the discretion of the police officer. Alternatively, the video image capture devices may be configured to record each time the lights/sirens in a police vehicle are activated. Video image intake station may parse the video images captured on the VHS tape into individual image files for each traffic stop or incident. According to one embodiment, the image files generated may be saved in a digital format.

According to an embodiment of the invention, the video image intake station may also collect (or intake/ingest) aural information. The aural information may comprise audio data (e.g., emergency 9-1-1 recordings) that may or may not be associated with a particular image file. In addition, a microphone or other audio-capture device may also be associated with the video image intake station to enable individuals to record commentary (e.g., spoken notes) that may be associated with particular image files.

Additional data files (e.g., word-processing files, spreadsheet files, etc.) metadata, or other information may be appended to, or otherwise associated with, an image file, as would be apparent. As but one illustrative example, a police officer or other individual may use an optical scanner or other digitization device associated with the video image intake station to scan in a traffic citation (or other document) corresponding to a traffic stop (or other incident) that is the subject of an image file.

Upon completion of the image file generation, one or more of the individual image files may be uploaded to a server. The server may host an evidence management application which may comprise an Internet web site, an intranet site, or other host site or application maintained by a service provider, or other entity. According to an embodiment of the invention, the evidence management application may comprise a security module, administration module, ingestion module, archive module, search module, and presentation module, each of which may implement the various features and functions as described herein.

According to an embodiment of the invention, copies of each uploaded image file may be stored in a plurality of formats (in a plurality of locations) to ensure that each image file is preserved.

For example, one copy of each image file may be created and stored in an archive on any suitable storage media (e.g., DVD-RAM, DVD-R, etc.). Each storage media (e.g., DVD-R) may comprise a plurality of image files. Each storage media may further comprise a unique identifier (e.g., bar-code label, tracking number, etc.). This unique identifier may be included in the metadata associated with each image file for facilitating later retrieval from the archive.

After a copy of an image file has been archived, an additional copy may be stored on a temporary storage device (associated with the server) for a predetermined period of time (e.g., hours, days, months, years, etc.). An administrator or other user may then review each image file and confirm its suitability for indexing and storage in a searchable database. If a particular image file is not reviewed within the pre-determined period, or is not selected for inclusion in the searchable database, it may be purged from the temporary storage device after the pre-determined time period has expired. Copies of purged image files may, however, be retained in the archive. The metadata for a purged image file may also be retained on the temporary storage device and/or placed in the searchable database.

According to an embodiment of the invention, copies of image files stored in the archive and searchable database may be read-only files. These copies may be time/date-stamped, and further secured using any known encryption or security technology (e.g., hashing algorithms). Copies of image files on the temporary storage device may be made available for extraction and modification (e.g., editing, redacting, etc.) as will be described in greater detail below. Alternative configurations may exist, as would be apparent to those having skill in the art.

According to an alternative embodiment, the temporary storage device and archive may be associated with the video image intake station, rather than the server. Accordingly, image files may be temporarily stored on a storage device associated with the video image intake station for a predetermined period of time (e.g., hours, days, months, years). An administrator or other user may review the image files and confirm their suitability for uploading to the server for indexing and storage in the searchable database.

Once image files or their associated metadata have been placed in a searchable database, individual image files may be searched and accessed by users who have been granted appropriate access rights by an administrator. Examples of users may include plaintiff attorney(s) or prosecution attorney(s), defense counsel, police officers or other law enforcement officials, potential witnesses, court officers (e.g., judges, clerks), investigators, or other users.

Users with an appropriate level of access rights may either download an image file, have an image file e-mailed to an Internet address, or output an image file in any known or suitable output format (e.g., to a CD-ROM, DVD, floppy disk, or other media) for further processing or analysis. These image files may comprise original, un-edited image files, and/or redacted or edited image files.

According to an embodiment of the invention, the evidence management application may interface to or be operable with any known post-processing applications including, but not limited to, facial recognition applications, voice analysis applications, or any other applications that enable enhancements of (or modifications to) image files.

Various objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 is a schematic diagram of a system for accepting, storing, retrieving, manipulating, and otherwise managing video images having potential evidentiary significance, in accordance with an embodiment of the invention.

FIG. 2 is a schematic diagram of an evidence management application, according to an embodiment of the invention.

FIG. 3 is an example of a view that may be presented to a user, according to an embodiment of the invention.

FIG. 4 illustrates an example of a view that may be presented to a user, according to an embodiment of the invention.

FIGS. 5A-5F each depict views that may be presented to a user, according to an embodiment of the invention.

FIGS. 6A-6E each depict views that may be presented to a user, according to an embodiment of the invention.

FIGS. 7A-7C each depict views that may be presented to a user, according to an embodiment of the invention.

FIG. 8 illustrates a flowchart of processing, according to the invention, in one regard.

FIG. 9 is a schematic diagram of a system for accepting, storing, retrieving, manipulating, and otherwise managing video images having potential evidentiary significance, in accordance with another embodiment of the invention.

FIG. 10 is a schematic diagram of a system for accepting, storing, retrieving, manipulating, and otherwise managing video images having potential evidentiary significance, in accordance with yet another embodiment of the invention.

### DETAILED DESCRIPTION OF PREFERRED EMBODIMENTS

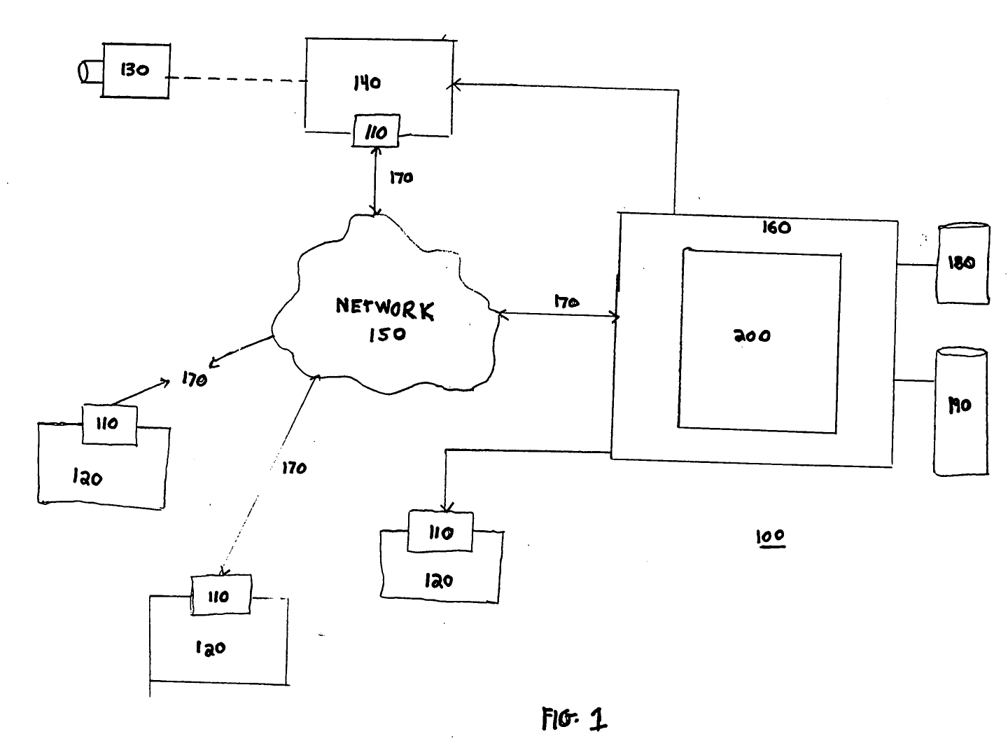

According to an embodiment of the invention illustrated in FIG. 1, a system 100 is provided for accepting, storing, retrieving, manipulating, and otherwise managing video images having potential evidentiary significance.

Video Image Capture Device

System 100 may include a video image capture device 130. According to an embodiment of the invention, video image capture device 130 may be utilized for public or private surveillance in a bank, casino, convenience store, retail establishment, public bus or subway, personal residence, or other institution or public transportation means. Video image capture device 130 could also be used to capture video images associated with medical procedures (e.g., in an operating room), or from a crime scene investigation. Additionally, video image capture device 130 may comprise a video image capture device utilized by law enforcement officials, including those mounted in a law enforcement vehicle.

Whether used for these or other purposes, video image capture device 130 may further comprise a digital video image capture device, an analog video image capture device, a digital still camera with video burst capability, or any other known device capable of capturing a video image.

A digital video image capture device may receive optical (or other from of electromagnetic radiation) information from a scene and transform the optical information into a digital video signal. The digital video signal may then be recorded onto a suitable recording medium such as a digital tape, disk drive, memory device, or a similar mechanism for storing digital information as would be apparent. The digital signal may also be communicated directly to a video image intake station 140 as a direct video feed via, for example, a wireless communication channel.

An analog video image capture device may receive optical information from a scene and transform the information into an analog video signal. The analog video signal may then be recorded onto a suitable recording medium such as a VHS tape, an 8 mm tape, or other known analog video recording medium.

A digital still camera with a video burst capability may capture a series of video still frames of a scene, and record them as a digital video signal. Generally, digital still cameras include a relatively small amount of memory or similar recording medium. This typically results in a digital video signal of relatively short duration (e.g., seconds). As improvements in technology continue, particularly in “memory stick” technology, the duration of a digital video signal from digital still cameras may increase.

Video Image Intake Station

According to an embodiment of the invention, video image intake station 140 may collect video images captured by video image capture device 130 for processing and/or uploading to a server 160, as described in greater detail below.

Video image intake station 140 may comprise hardware to process the video images regardless of the format (or recording medium) of video image capture device 130.

For example, according to an embodiment, a video image capture device 130 mounted in a law enforcement vehicle may record video images to an analog medium, such as a VHS tape. According to an embodiment, several traffic stops or other incidents/events may be recorded. Such incidents may be recorded at the discretion of the law enforcement official (e.g., police officer). Alternatively, video image capture device 130 may be configured to record each time the lights/sirens in a law enforcement vehicle are activated.

At the conclusion of each police officer's shift, or at another predetermined interval, the VHS tape may be provided to a digitizer associated with video image intake station 140 so that the analog video signals can be digitized for further processing. Other types of hardware comprising video image intake station 140 may include a video capture board, an i.Link™ port, a multiplexor for multiplexing video signals collected using a plurality of channels, or other device.

According to another embodiment, video image intake station 140 may also serve as a fully functional interface to a network 150, which will be described in greater detail below. This may enable digital video images to be received in a digital medium. In such an instance, video image intake station 140 may further comprise a personal computer, portable computer, workstation, terminal, or other device, each of which may include a disk drive (e.g., a 3.5″ floppy drive), a memory interface (e.g., a PCMCIA memory interface) or other similar hardware memory interface, including an interface for reading memory sticks.

In addition to accepting video images in a plurality of formats (e.g., VHS, VHS-C, 8 mm, Hi8, Digital 8, DV, or others), video image intake station 140 may be used to further process the video images to create individual video image files. This process may be employed to select sequences of video images for indexing, archiving, and potential presentation. For example, a video image capture device 130 mounted in a police vehicle may record video images to a VHS tape during a particular time interval (e.g., 1 hour, 2 hours, etc.). During this time interval, several traffic stops or other incidents may be recorded. Video image intake station 140 may parse the video images captured on the VHS tape into individual image files for each traffic stop or incident. This may facilitate later searching, as several hours of an entire VHS tape will no longer have to be viewed to find, for example, a 15 minute traffic stop during which a sobriety test was administered.

According to an embodiment of the invention, the individual image files generated at video image intake station 140 may be saved in a plurality of formats as well. Each image file may receive an individual file name, file number, or other metadata to facilitate indexing of the image files for later searching.

According to an embodiment of the invention, video image intake station 140 may also collect (or intake/ingest) aural information. The aural information may comprise audio data (e.g., emergency 9-1-1 recordings) that may or may not be associated with a particular image file. In addition, a microphone or other audio-capture device may also be associated with video image intake station 140 to enable individuals to record commentary (e.g., spoken notes) that may be associated with particular image files.

Additional data files (e.g., word-processing files, spreadsheet files, etc.) metadata, or other information may be appended to, or otherwise associated with, an image file, as would be apparent. As but one illustrative example, a police officer or other individual may use an optical scanner or other digitization device associated with video image intake station 140 to scan in a traffic citation (or other document) corresponding to a traffic stop (or other incident) that is the subject of an image file.

In a preferred embodiment, video image intake station 140 may save individual image files in a digital format, and upload the files to server 160. Video image intake station 140 may be networked directly to server 160, or may be connected over a network 150, via a communications link 170.

Network and Communications Link

Network 150 may include any one or more of, for instance, the Internet, an intranet, a PAN (Personal Area Network), a LAN (Local Area Network), a WAN (Wide Area Network), a SAN (Storage Area Network), or a MAN (Metropolitan Area Network).

Communications link 170 may include any one or more of, for instance, a copper telephone line, a Digital Subscriber Line (DSL) connection, a Digital Data Service (DDS) connection, an Ethernet connection, an Integrated Services Digital Network (ISDN) line, an analog modem connection, a cable modem connection, or a wireless connection.

Server

According to an embodiment of the invention, server 160 may be or include, for instance, a workstation running Microsoft Windows™ NT™, Microsoft Windows™ 2000, Unix, Linux, Xenix, IBM, AIX™, Hewlett-Packard UX™, Novell Netware™, Sun Microsystems Solaris™, OS/2™, BeOS™, Mach, Apache, OpenStep™, or other operating system or platform. According to an embodiment of the invention, server 160 may host an evidence management application 200.

Evidence Management Application

Evidence management application 200 may comprise an Internet web site, an intranet site, or other host site or application maintained by a service provider, or other entity.

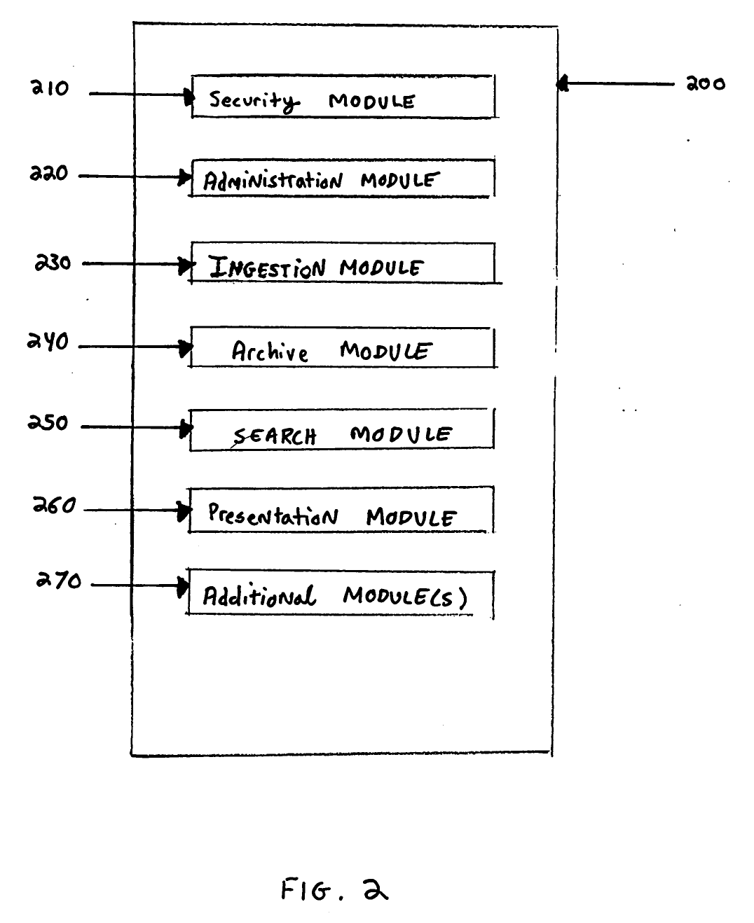

As illustrated in FIG. 2, and described in greater detail below, evidence management application 200 may further comprise a security module 210, administration module 220, ingestion module 230, archive module 240, search module 250, presentation module 260, and additional module(s) 270, each of which may implement the various features and functions (as described herein) that aid in accepting, storing, retrieving, manipulating, and otherwise managing video images having potential evidentiary significance. One or more of the modules comprising evidence management application 200 may be combined. For some purposes, not all modules may be necessary.

Database and Archive

According to an embodiment of the invention, and as illustrated in FIG. 1, at least one database 180, archive 190, and temporary storage device (not illustrated) may be operatively connected to server 160.

According to an embodiment of the invention, copies of each uploaded image file may be stored in a plurality of formats (in a plurality of locations) to ensure that each image file is preserved.

For example, one copy of each image file may be created and stored in archive 190 on any suitable storage media (e.g., DVD-RAM, DVD-R, etc.). Each storage media (e.g., DVD-R) may comprise a plurality of image files. Each storage media may further comprise a unique identifier (e.g., bar-code label, tracking number, etc.). This unique identifier may be included in the metadata associated with each image file for facilitating later retrieval from archive 190.

After a copy of an image file has been archived, an additional copy may be stored on the temporary storage device (associated with the server) for a predetermined period of time (e.g., hours, days, months, years, etc.). An administrator or other user may then review each image file and confirm its suitability for indexing and storage in searchable database 180. Database 180 may be include, or interface to, for example, an Oracle™ relational database sold commercially by Oracle Corporation. Other databases, such as Informix™, DB2 (Database 2) or other data storage or query formats, platforms, or resources such as OLAP (On Line Analytical Processing), SQL (Standard Language Query), a SAN (storage area network), Microsoft Access™ or others may also be used, incorporated, or accessed into the invention.

If a particular image file is not reviewed within the pre-determined period, or is not selected for inclusion in database 180, it may be purged from the temporary storage device after the pre-determined time period has expired. Copies of purged image files may, however, be retained in archive 190. The metadata for a purged image file may also be retained on the temporary storage device and/or placed in database 180.

According to an embodiment of the invention, copies of image files stored in archive 190 and database 180 may be read-only files. These copies may be time/date-stamped, and further secured using any known encryption or security technology (e.g., hashing algorithms). Copies of image files on the temporary storage device may be made available for extraction and modification (e.g., editing, redacting, etc.) as will be described in greater detail below. Alternative configurations may exist, as would be apparent to those having skill in the art.

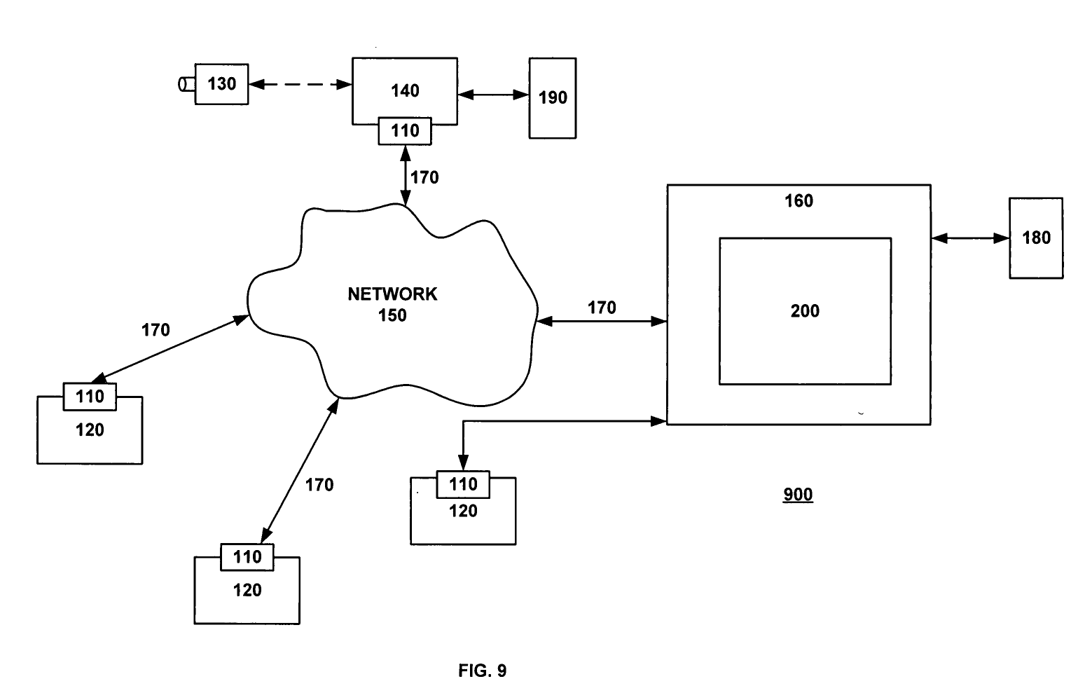

According to an alternative embodiment, the temporary storage device and archive 190 may be associated with video image intake station 140, rather than the server 160 such as illustrated in FIG. 9. Accordingly, image files may be temporarily stored on a storage device associated with video image intake station 140 for a predetermined period of time (e.g., hours, days, months, years). An administrator or other user may review the image files and confirm their suitability for uploading to server 160 for indexing and storage in database 180.

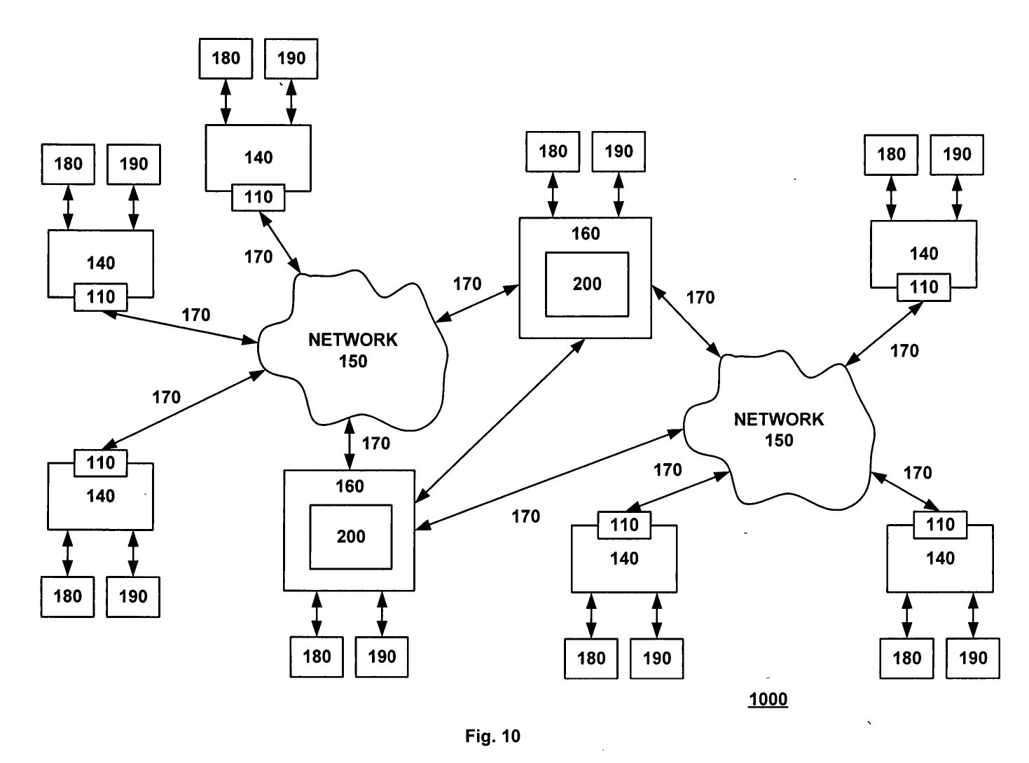

FIG. 10 illustrates another embodiment of the invention illustrating a network 1000 of video image intake stations 140 each associated with one or more of a temporary storage device, an archive 190, and a searchable database 180. These video image intake stations 140 may be integrated with one or more servers 160 that may also include an archive 190 and one or more databases 180. These servers 160 may be coupled together for providing various information including or derived from the image files. A network 1000 may be useful for law enforcement and/or security efforts at the precinct, district, county, state, regional, jurisdiction, agency and/or national level as will become apparent from this specification.

For example, image files and/or metadata or other information associated with the image files, may be searched. This metadata may include various parameters associated with the image files including, but not limited to, facial recognition parameters extracted from the image files using various known techniques that subsequently may be used to track, locate, and/or identify certain people.

User Terminal and User Interface

In operation, one or more users may access server 160 and evidence management application 200 through an interface. As described in greater detail below, users accessing evidence management application 200 may include a management application administrator, plaintiff attorney(s) or prosecution attorney(s), defense counsel, police officers or other law enforcement officials, potential witnesses who may be called to testify based on the events captured in the image file, and court officers (e.g., judges, clerks). Other users may also access evidence management application 200.

By way of example, server 160 may comprise a web server and the interface may comprise a web browser. Those having skill in the art will recognize that other client/server and network configurations may be used.

According to an embodiment, the interface may comprise a graphical user interface (GUI) 110. GUI 110 may display various modules and functions of evidence management application 200 available to a user via a terminal 120. Terminal 120 may be networked directly to server 160 or connected over network 150, via communications link 170.

Examples of terminal 120 may include any one or more of, for instance, a personal computer, portable computer, PDA (personal digital assistant), workstation, dumb terminal, web-enabled mobile phone, WAP device, web-to-voice device, or other device.

Those having skill in the art will appreciate that the invention described herein may work with various system configurations. Accordingly, more or less of the aforementioned system components may be used and/or combined in various embodiments.

Views

It should be understood that the views described in detail below, and illustrated in the accompanying drawing figures, are exemplary and may differ in appearance, content, and configuration. Further, and as may be described herein, the terms “button,” “pull-down menu,” “tab,” “click-box,” “check-box,” “hypertext link,” and “hot link,” are each particular examples of a generic “selection portion” which may comprise any known navigational tool that enables users to select, access, display, or navigate through the various views, portions, or modules of evidence management application 200. The selection portions may be accessed using any known input device associated with terminal 120 such as, for example, a keyboard, computer mouse, light stylus instrument, or finger or other body part in a touch-screen implementation.

While a selection portion may be described and illustrated as a button in one embodiment, it could comprise a different selection portion (e.g., a check-box) in an alternative embodiment. These selection portions may be present in addition to the various navigational tools that may be unique to, or associated with, a web browser (e.g., Netscape™) or other GUI 110 used to access evidence management application 200.

Additionally, each of the views may further include a display of text, a logo, or any other icon, symbol, or graphic. Such indicia may serve an aesthetic function, or may display an advertisement, or a trademark (or graphic) identifying the service provider or entity maintaining evidence management application 200, or the entity (e.g., a law enforcement agency, jurisdiction) for which evidence management application 200 was adapted.

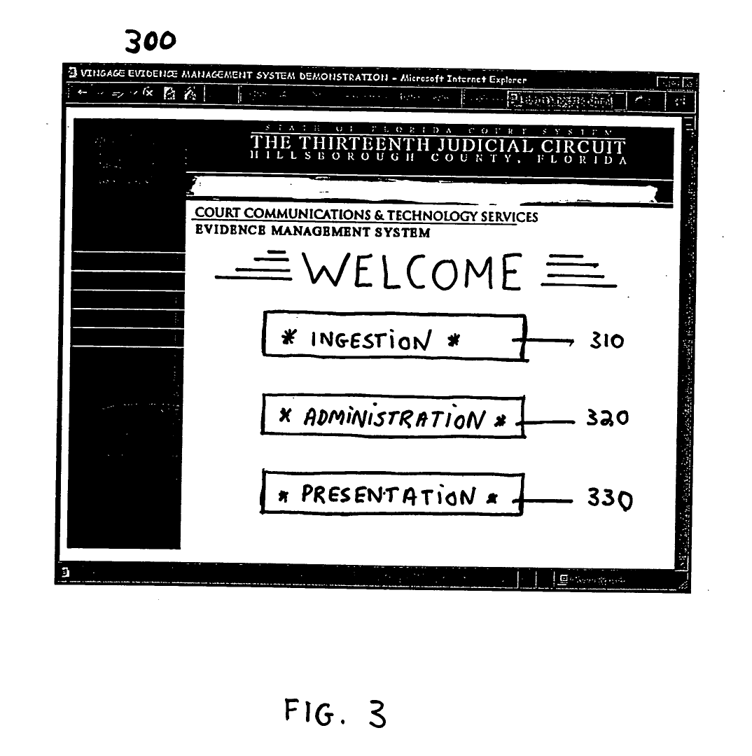

According to an embodiment of the invention, FIG. 3 illustrates an example of a main screen display or view 300 that may first be presented to a user in GUI 110 when evidence management application 200 is accessed. According to one implementation of the invention, a user, depending on their authorization, may select an “ingestion” button 310, an “administration” button 320, and a “presentation” button 330 to access and utilize the various features and functionality of the invention. Other selection portions may also be presented in main view 300.

Ingestion Views/Functionality

According to an embodiment of the invention, a user may access evidence management application 200 from video image intake station 140, via GUI 110. The user may, for instance, comprise an administrator responsible for the collection of video images at video image intake station 140. The user may also comprise a police officer or other law enforcement personnel present when the video images were captured.

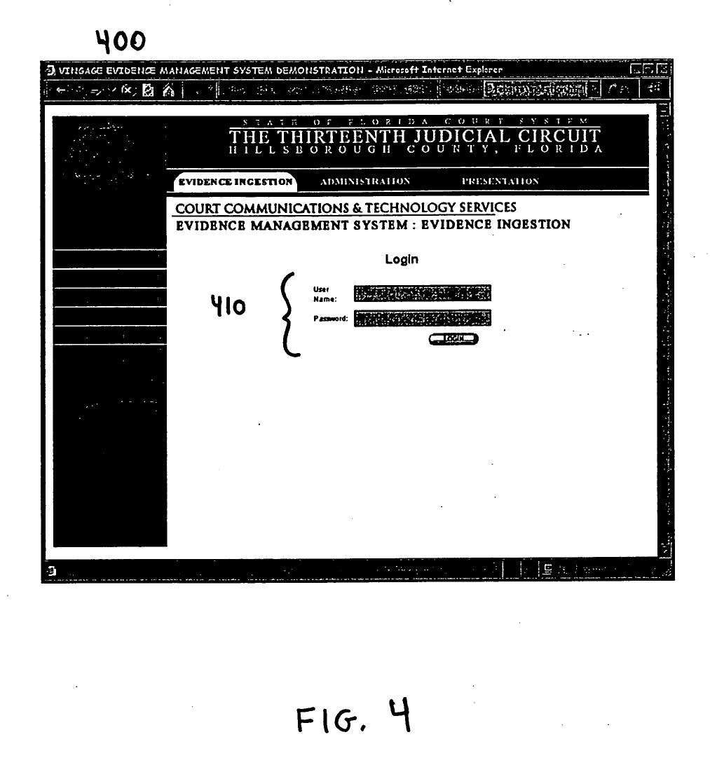

To begin the process of collecting video images captured by video image capture device 130, a user may select “ingestion” button 310 in main view 300 (FIG. 3). Upon making this selection, a user may be presented with view 400, as illustrated in FIG. 4.

View 400, which may be generated by security module 210, may comprise a data field 410 wherein a user may input his or her identification information (e.g., username and password) to access the various features and functionality associated with ingestion module 230. In some embodiments, a log-in procedure may not be required.

If the log-in procedure is successful, a user may, according to an embodiment of the invention, be presented with view 500, as illustrated in FIG. SA. View 500 may include selection portions to enable a user to collect (or “ingest”) video images regardless of the format (or recording medium) of video image capture device 130.

For example, as illustrated in view 500, video image intake station 140 may comprise at least two VHS tape decks (A and B) for receiving video images recorded on VHS tapes from a VHS camera mounted in a police vehicle. Once either or both of the VHS tapes have been placed in their respective tapes decks, a user may select the “ingest video A” button 502 and/or the “ingest video B” button 504 to begin the video image intake (or “ingestion”) process.

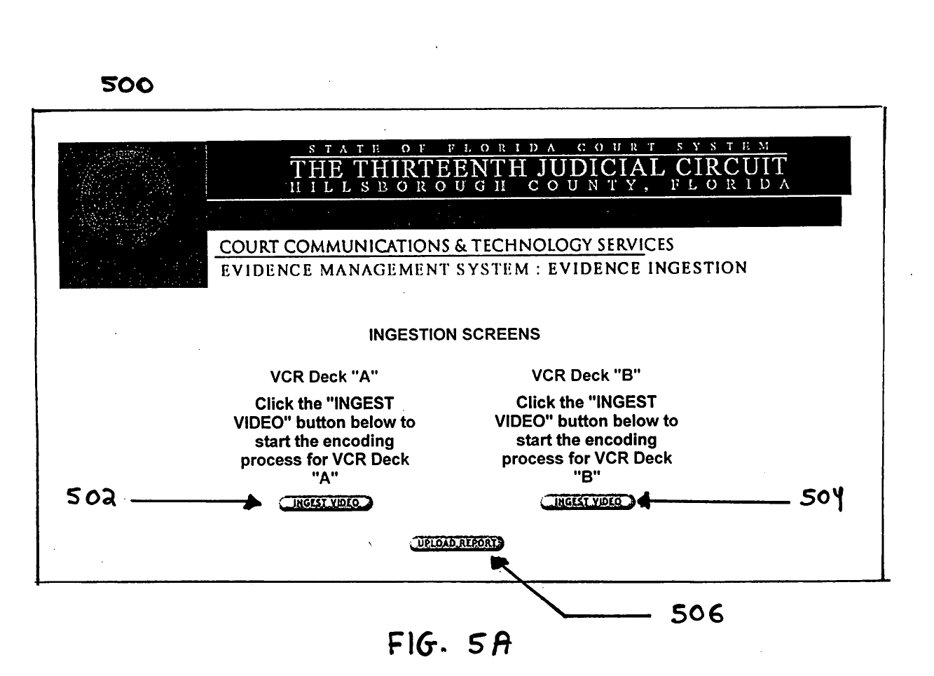

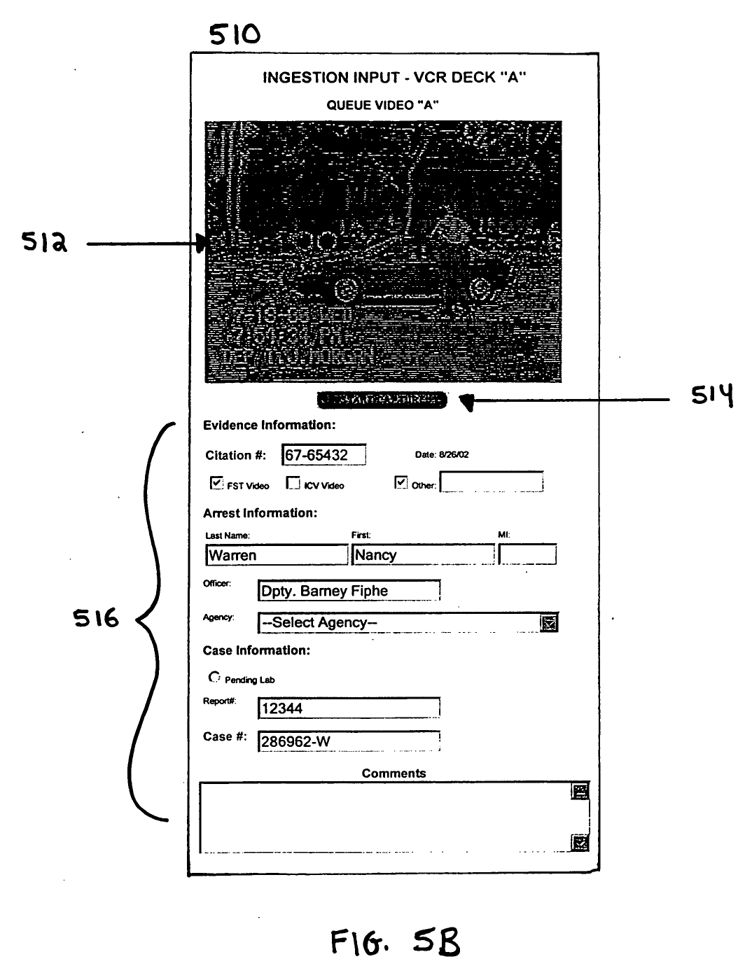

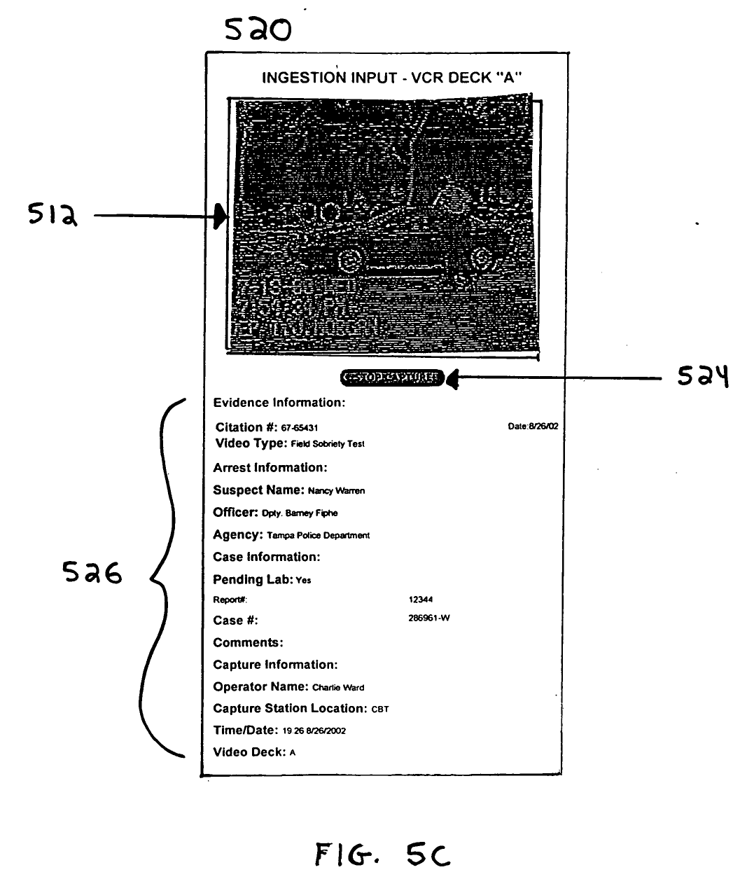

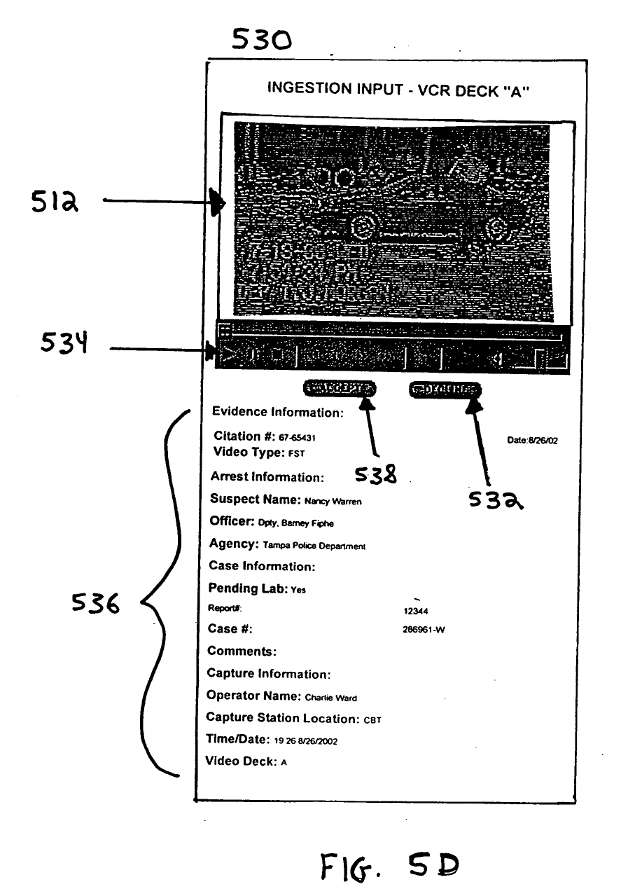

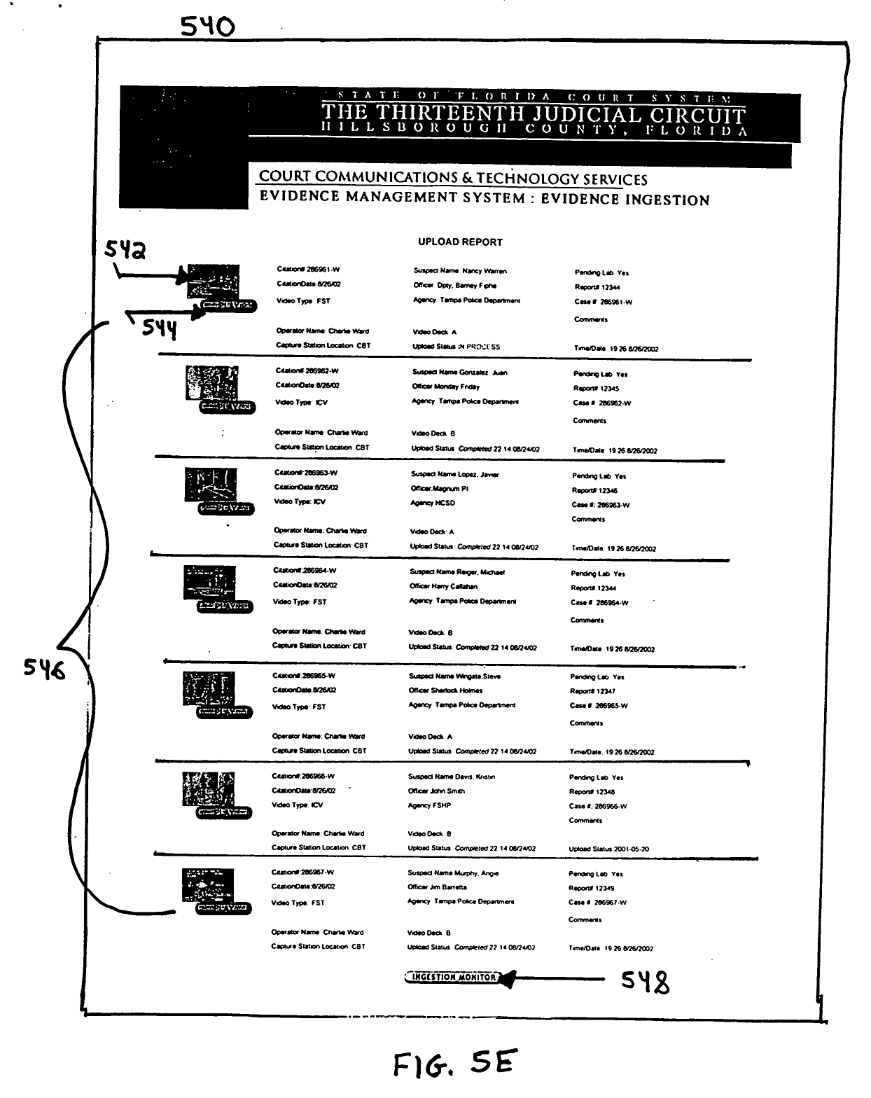

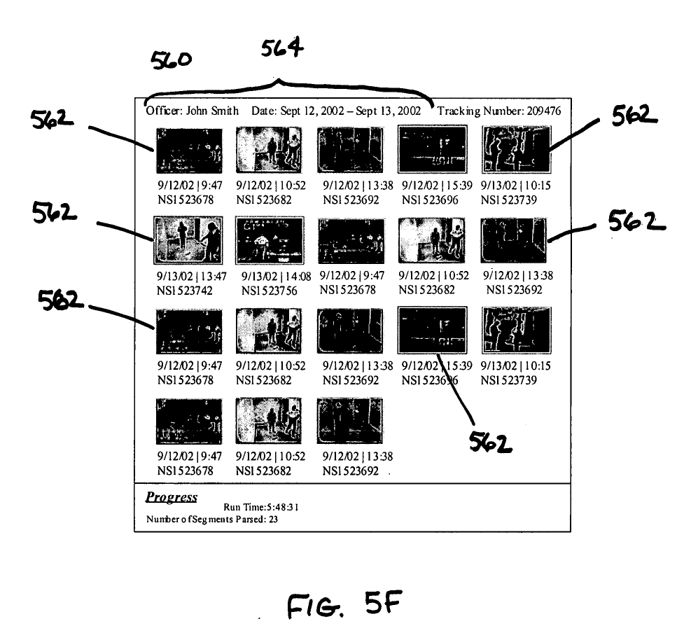

Assuming, for illustrative purposes, that a user wants to commence the ingestion process for one tape, he or she may place the VHS tape in VHS tape deck A and select “ingest video A” button 502. At this point, ingestion module 230 may generate a view 510, illustrated in FIG. 5B, to be displayed to the user.

As shown in FIG. 5B, view 510 may comprise a data field 516 for enabling a user to input various identification data for each related sequence of video images (e.g., for each traffic stop) for indexing and searching purposes. Examples of information that a user may input in data field 516 may include, for example: a citation or ticket number; arrest information if applicable, the name of the individual receiving the ticket (or being arrested); the police officer's name; the law enforcement agency for which the officer is working; additional corresponding report or case numbers; and additional comments. Other information may be provided.

Once data field 516 has been completed, a user may select “start capture” button 514. Upon selecting the “start capture” button 514, the video images from VHS tape deck A may appear in display window 512 and play in real-time.

At this point, according to an embodiment of the invention, ingestion module 230 may generate and display view 520 to a user. As illustrated in FIG. 5C, view 520 may also comprise display window 512. All of the information previously entered in data field 516 (in view 510) may be reproduced in data field 526. A “stop capture” button 524 may also be provided for selection when the sequence of video images corresponding to a particular incident (e.g., a traffic stop) is complete. Upon selecting “stop capture” button 524, ingestion module 230 may generate a unique image file corresponding to the series of video images just captured. Although not illustrated, a user may also have the capability to specify the format in which the image file may be created (e.g., an MPEG file).

Upon selecting “stop capture” button 524, a user may also be presented with view 530, as depicted in FIG. 5D. View 530 may comprise an array of presentation controls 534 (e.g., play, stop, pause, fast forward, rewind, etc.) that enable a user to preview the image file just generated by viewing it in display 512.

According to an embodiment of the invention, a commercially available media player such as, for instance, Windows™ Media Player or RealOne™ Player may be incorporated into the invention for previewing the image file.

View 530 may also comprise a data field 536 for displaying the information previously entered in data field 516 (in view 510). After previewing the image file, a user may either select the “accept” button 538 or the “decline” button 532 depending on whether or not he or she wishes to save the image file for subsequent processing.

According to an embodiment of the invention, if a user chooses to accept the image file, ingestion module 230 may save the file to an upload list for subsequent processing. As shown in view 540, illustrated in FIG. 5E, the upload list may comprise an array 546 of each of the image files generated by ingestion module 230 and saved. For each image file listed in file array 546, metadata pertaining to each image file may be displayed, along with a thumbnail 542 illustrating the image file. By selecting a “play” button 544 associated with the thumbnail 542 for each image file, a user may also preview the image file from this view 540. An “ingestion monitor” button 548 may be selected to return a user back to view 500 (FIG. 5A).

By contrast, if a user chooses to decline the image file in view 530, the file may not be saved to the upload list, and he or she may be returned to view 500 by selecting the “decline” button 532. The ingestion process may be repeated by a user during a particular session until the necessary image files have been generated according to the process set forth immediately above. At this point, according to an embodiment of the invention, a user may select the “upload report button” 506 in view 500 to upload the generated image files to server 160 for further processing by evidence management application 200.

As described herein, ingestion module 230 automatically collects video images and converts them into individual images files with minimal user intervention. For example, once the VHS tapes are loaded and some preliminary information entered by the user, ingestion module 230 converts the video images into individual files by a parsing mechanism such as, for example, size, duration, scene changes, stop/start information, date/time stamps or other parsing mechanism as would be apparent. Once or as conversions are completed, ingestion module 230 may present an initial portion, or preview, of each of the video image files as thumbnail images 562 such as those illustrated in a view 560 in FIG. 5F. Additional information, such as preliminary information 564 may or may not also be presented. In some embodiments, each thumbnail image 562 may be obtained from the first frame of the image file; whereas in other embodiments, each thumbnail image 562 may be obtained from the n-th frame, or other portion of the image file. This preview thumbnail image 562 may allow the user to rapidly retrieve a particular image file from among those ingested from a particular tape or tapes. As would be appreciated, thumbnail image 562 may be used to select and playback the corresponding video image file.

The various views generated by ingestion module 230 (e.g., FIGS. 5A-5F) may of course differ with varying embodiments and should thus not be viewed as limiting. Additionally, although the foregoing description and corresponding illustrations were directed toward the intake of video images on one VHS tape A, it should be understood that the ingestion process may occur simultaneously with two VHS tapes (A and B), or with any combination of recording media on which video images have been captured.

According to an alternative embodiment of the invention, video image intake station 140 may further collect video images and convert them into individual image files without having to access ingestion module 230 of evidence management application 200. For example, as Other configurations are possible.

Administration Views/Functionality

According to an embodiment of the invention, an administrator may access evidence management application 200 from terminal 120, via GUI 110. The administrator may, for instance, comprise a user associated with a particular law enforcement agency responsible for maintaining evidence management application 220. The administrator may also comprise a user associated with a service provider or other entity responsible for maintaining evidence management application 200. Other users may act as an administrator in accordance with various alternative embodiments.

To access the various views and functionality enabled by administration module 220, an administrator may select “administration” button 320 in main view 300 (FIG. 3). Although not illustrated, upon making this selection, an administrator may be presented with a “log-in” view generated by security module 210, which may be similar to view 400 as illustrated in FIG. 4. In some embodiments, a log-in procedure may not be required for administrators.

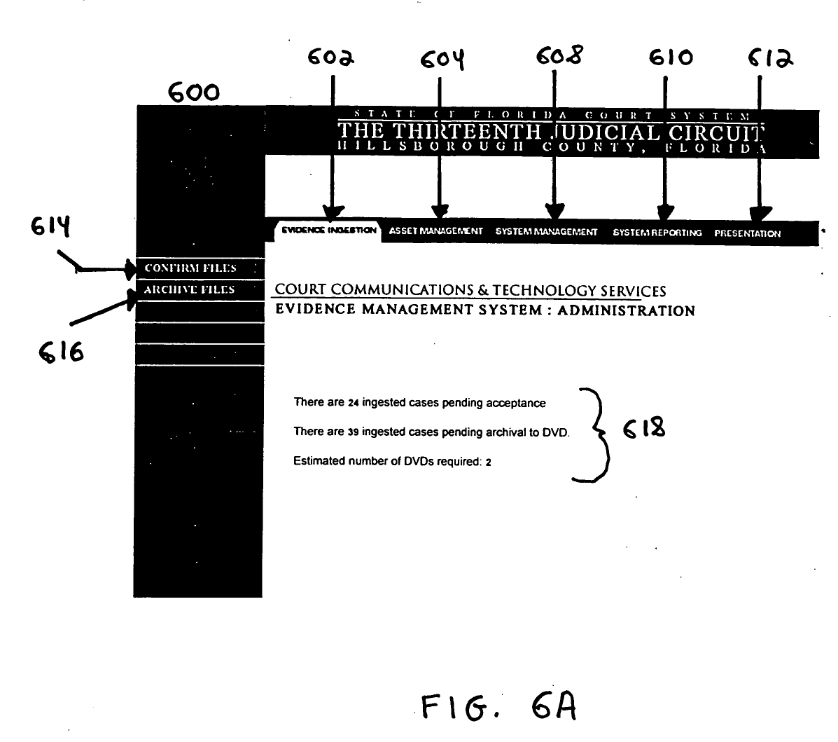

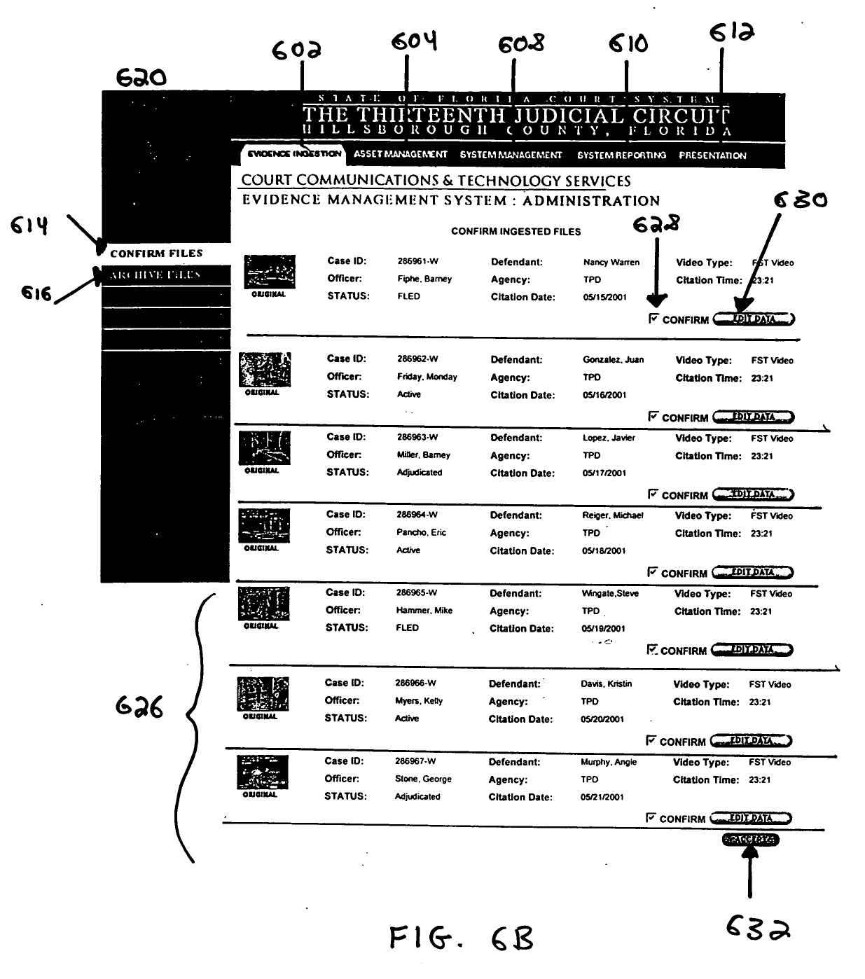

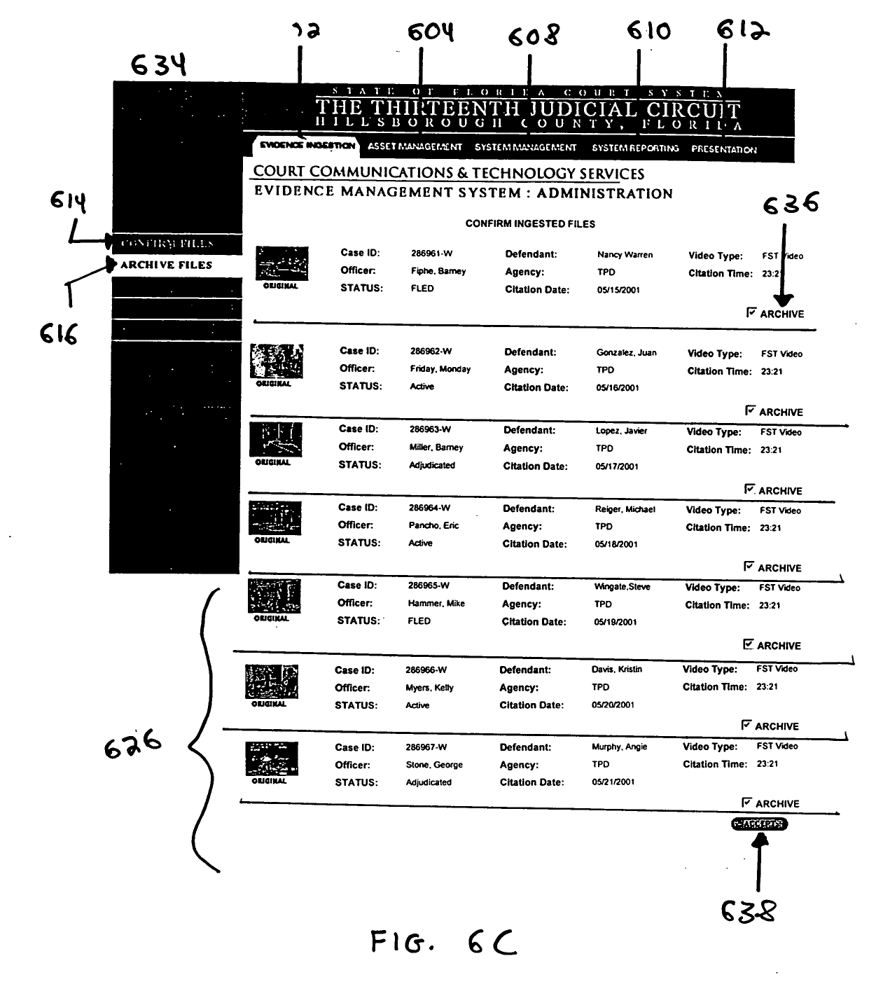

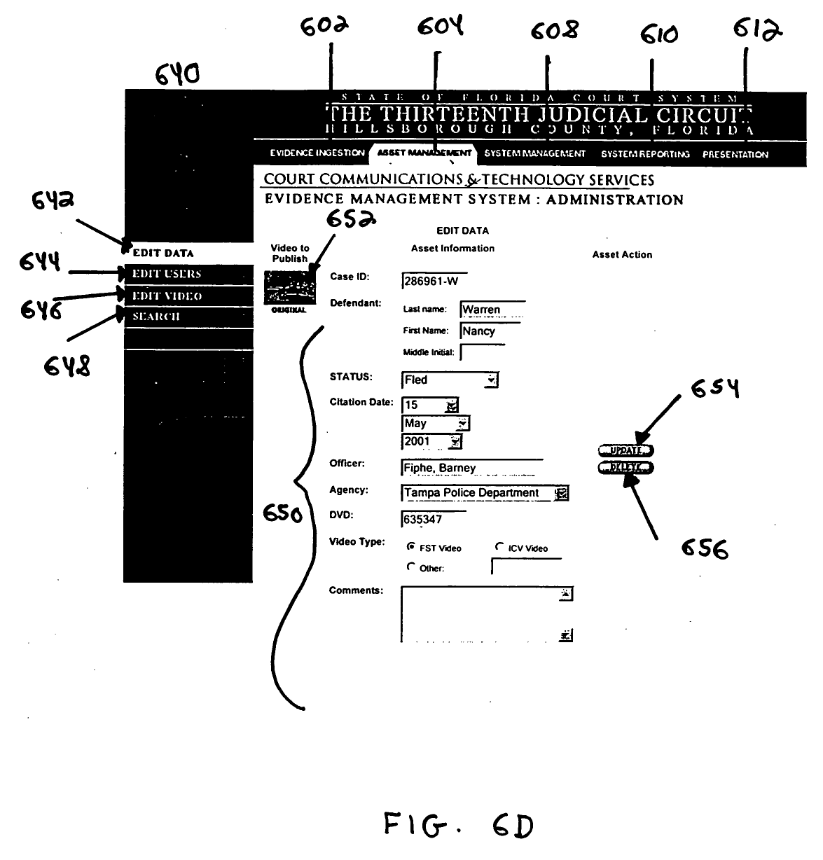

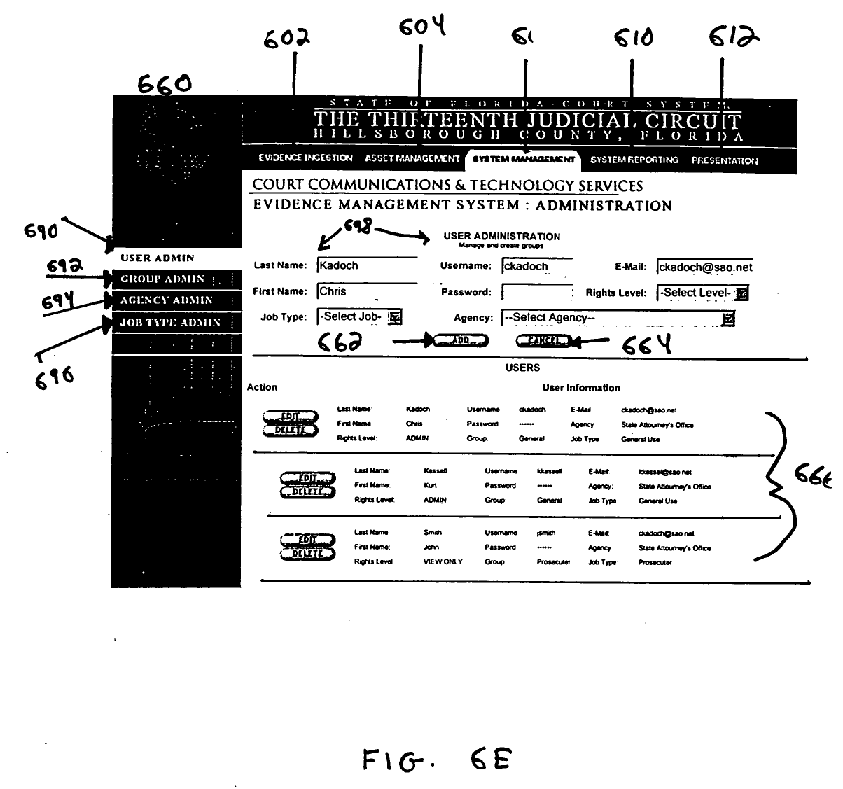

If the log-in procedure is successful, an administrator may, according to an embodiment of the invention, be presented with view 600, as illustrated in FIG. 6A. An “evidence ingestion” tab 602, “asset management” tab 604, “system management” tab 608, “system reporting” tab 610, “presentation” tab 612, or other tabs may be displayed in view 600, each of which may enable an administrator to access the various features and functionality controlled, in part, by administration module 220.

According to an embodiment of the invention, “evidence ingestion” tab 602 may be the default tab selected when view 600 is first displayed to an administrator. View 600 may also include a status display 618 that lists, for example, the number of image files (or cases) that have been ingested at video image intake station 140 and uploaded to server 160 via the process described above and illustrated in FIGS. 5A-5E. Status display 618 may also include a list of the number of cases pending archival to archive 190, as illustrated in FIG. 1, as well as an estimated number of recording media (e.g., DVD) necessary to archive the image files.

According to an embodiment of the invention, when “evidence ingestion” tab 602 is selected, an administrator may elect to confirm or archive image files that have been ingested by selecting “confirm files” button 614 or “archive files” button 616, respectively.

If an administrator selects “confirm files” button 614, he or she may be presented with view 620, as shown in FIG. 6B. View 620 may display a file array 626 which lists each image file that has been ingested and uploaded to server 160 by the processing operations of ingestion module 230.

For each image file listed in file array 626, an administrator may choose to edit the data associated with the image file by selecting “edit data” button 630. An administrator may also preview the image file by “clicking-on” a thumbnail of the image file as illustrated. If an administrator is satisfied with the image file, he or she may select the “confirm” check box 628 for that image file. Once an administrator has reviewed all of the files in file array 626, he or she may select “accept” button 632 to save the image files to database 180 (FIG. 1) for later searching and analysis.

If an administrator selects “archive files” button 616 in either view 600 or view 620, he or she may be presented with view 634, as illustrated in FIG. 6C.

File array 626 may list each image file confirmed by an administrator in view 620. For each image file listed, an administrator may determine whether or not he or she would like to send a copy to archive 190 by selecting “archive” check box 636 for that image file. Once all files have been selected for archiving, an administrator may select “accept” button 638. Archive module 240 may then transfer a copy of the image files to archive 190 for back-up storage. A copy of each image file may, however, be retained in database 180 for searching and processing by those accessing evidence management application 200.

According to an embodiment of the invention, a copy of each image file confirmed by an administrator in view 620 may automatically be archived to archive 190 as a matter of course.

According to an embodiment of the invention, when “asset management” tab 604 is selected, administration module 220 may generate view 640 (shown in FIG. 6D) for presentation to an administrator. View 640 may include an “edit data” button 642, “edit users” button 644, “edit video” button 646, “search” button 648, or other buttons.

When “edit data” button 642 is selected, as seen in view 640, an administrator may be presented with a data field 650 displaying information for each particular image file. A thumbnail 652 of each image file may also be provided to enable an administrator to preview the image file. Information corresponding to each image file may be edited or updated by selecting “update” button 654. If an administrator desires to delete a particular image file, he or she may select “delete” button 656. Although the image file may then be deleted from database 180, a copy may still be retained in archive 190.

Although not illustrated, additional functionality may be provide to administrators when “edit users” button 644, “edit video” button 646, and “search” button 648 are selected.

For example, when an administrator selects “edit users” button 644, administration module 220 and security module 210 may enable the administrator to modify access rights to evidence management application 200 for existing users. Profiles for each user may exist including, for example, a user's name, e-mail address, contact information, and rights or access level to evidence management application 200. Access rights may differ for the same or other individuals on a case-by-case basis. Other user information may be provided.

According to an embodiment of the invention, an administrator may select “edit video” button 646 to redact or otherwise edit an image file. For example, in a court proceeding, a judge or other court officer may make a determination that only a portion of a particular image file comprises admissible evidence for viewing by the jury. In such an instance, an administrator, court officer, or other user with appropriate access rights may edit the video. The original image file may be retained, and a new, edited file may be created, stored, indexed for future searching, and also archived.

“Search” button 648 may be selected by an administrator to enable them to search for a particular image file or group of related image files (e.g., for a particular police officer, law enforcement agency, jurisdiction, etc.), and to view the results. This processing may be controlled by search module 250 together with administration module 220.

According to an embodiment of the invention, when “system management” tab 608 is selected, administration module 220 may generate view 660, illustrated in FIG. 6E, for presentation to an administrator. View 660 may include a “user admin” button 690, “group admin” button 692, “agency admin” button 694, “job type admin” button 696, or other buttons.

When “user admin” button 690 is selected, for instance, an administrator may create new profiles for each user desiring access to evidence management application 200. As described above, profiles for each user may be created by providing a user's name, e-mail address, contact information, rights or access level to evidence management application 200, and other information in data field 698. When the designated information has been entered in data field 698, an administrator may select “add” button 662 to add the user to the system. Selecting “cancel” button 664 may abort the process. A list of users may be displayed in user list 666. This and other functionality may be provided by administration module 220 and security module 210.

According to an embodiment of the invention, “group admin” button 692 may be selected to enable an administrator to create, delete, or modify profiles for groups of individuals wherein the categorization may determine their level of access rights to evidence management application 200. Examples of groups may include, but are not limited to, police officers, court officers, prosecutors, defenders, witnesses, etc.

According to an embodiment of the invention, “agency admin” button 694 may be selected to enable an administrator to create, delete, or modify profiles for agencies whose employees may have access to evidence management application 200. Examples of agencies may include, but are not limited to, a state attorneys office, a law firm, a courthouse, etc.

Similarly, an administrator may select “job type admin” button 696 to create, delete, or modify profiles for groups of individuals wherein their job type may determine their level of access rights to evidence management application 200. Examples of job types may include, but are not limited to, attorney, judge, police officer, etc.

Although not illustrated, various searching capabilities may be made available to administrators together with the ability to generate system-use reports or logs by selecting “system reporting” tab 610. For example, an administrator may search for a particular image file or group of related image files (e.g., for a particular police officer, law enforcement agency, jurisdiction, etc.), and/or generate reports detailing which users have accessed evidence management system 200 at which times, and have performed which operations. These reports may be exported to any known spreadsheet applications (e.g., Microsoft Excel™), external devices (e.g., printer) or saved to a storage medium (e.g., floppy disks, CD-ROM). Administration module 220 may also provide further functionality when “system reporting” tab 610 is selected.

According to an embodiment of the invention, selecting “presentation” tab 612 may enable an administrator to specify how image files may be viewed. This functionality will be described in detail below.

The various views described above (e.g., FIGS. 6A-6E) and the features illustrated therein may be controlled by one or more of security module 210, administration module 220, ingestion module 230, archive module 240, search module 250, and presentation module 260. According to various embodiments, one or more of these modules may be combined. For some purposes, not all modules may be necessary. The views may of course differ with varying embodiments and should thus not be viewed as limiting.

Presentation Views/Functionality

Referring back to FIG. 3, plaintiff attorney(s) or prosecution attorney(s), defense counsel, police officers or other law enforcement officials, potential witnesses, court officers (e.g., judges, clerks), investigators, and other users may select “presentation” button 330 in main view 300 to access the various views and functionality enabled by presentation module 260. As illustrated in FIG. 1, and described above, these users may access evidence management application 200 from terminal 120, via GUI 110.

Although not illustrated, upon making this selection, each of the aforementioned users may be presented with a “log-in” view generated by security module 210, which may be similar to view 400 as illustrated in FIG. 4. In some embodiments, a log-in procedure may not be required.

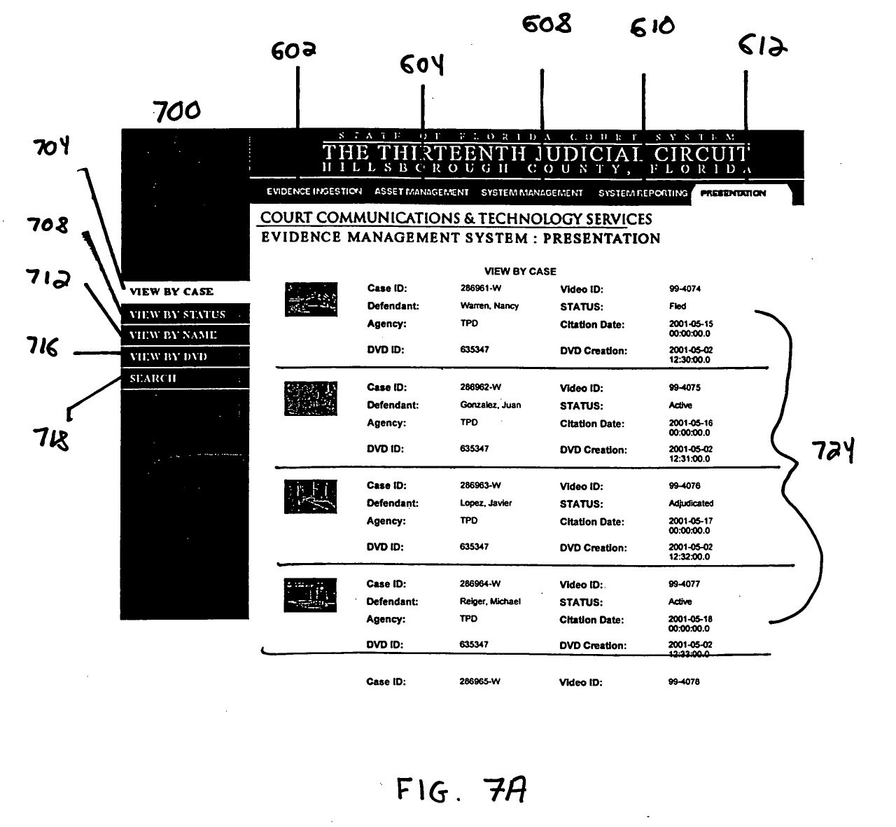

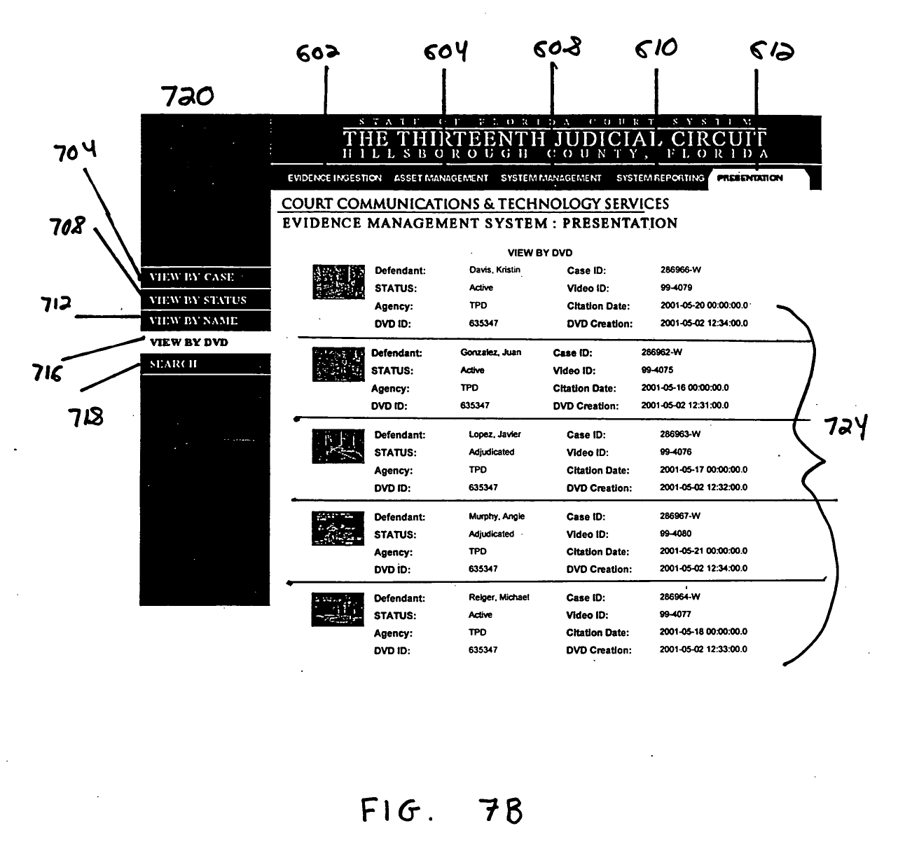

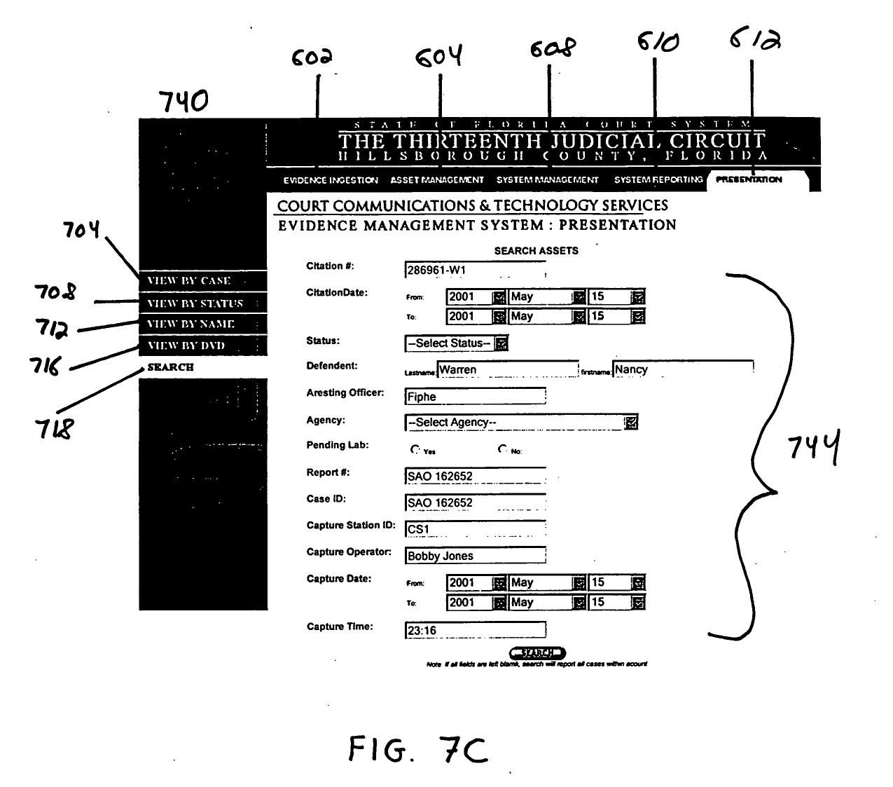

If the log-in procedure is successful, a user may, according to an embodiment of the invention, be presented with view 700, as illustrated in FIG. 7A. View 700 may be a default view displayed when “presentation” tab 612 is selected. While an administrator may have access rights which enable them to access the functionality of evidence management application 200 via tabs 602, 604, 608, and 610 from view 700, most other users may be restricted to the features available under “presentation” tab 612. In other words, after a log-in, most users may be presented directly with view 700.

As illustrated in FIG. 7A, users may have the ability to view a listing of image files by case, by case status, by subject name, or by the storage medium (e.g., DVD) of archive 190. These options may be controlled by presentation module 260, and may be exercised through the selection of a “view by case” button 704, “view by status” button 708, “view by name” button 712, and “view by DVD” button 716, respectively. Other viewing options may be available.

Users may also have the option to search for various image files based on metadata associated with the image files by selecting “search” button 718. This feature, enabled by search module 250 and/or presentation module 260, will be described in greater detail below.

According to an embodiment of the invention, a user may select “view by case” button 704 to view a listing of image files by case number, or similar identifying metadata. An image file list 724 may display each image file arranged according to case number.

Although not illustrated, a user may select “view by status” button 708 in view 700 to view a listing of image files by corresponding status in a legal proceeding. For instance, a user may wish to view a listing of image files for all cases pending in a court or before a particular judge. Image files may also be presented for all subjects (e.g., defendants) that have failed to appear in a court proceeding. Other status metrics may be utilized.

Selecting “view by name” button 712 may enable a user to view a listing of image files associated with a particular individual, whether that individual be a defendant, a police officer who may have captured the video images comprising the image file, or any other individual.

According to an embodiment of the invention, view 720 may be generated by presentation module 260 and presented to users when “view by DVD” button 716 is selected in view 700. As recited above, copies of each image file may be placed in archive 190 for storage on any one of a number of known storage mediums (e.g., DVD). During the archival process, controlled in part by archive module 240, metadata associated with each image file may be updated to include an identification number or other indexing marker for the storage medium on which the image file is archived. In an embodiment wherein image files may be archived on DVDs, for example, a DVD identification number may be included with the metadata for each image file, as illustrated in view 720.

Users accessing evidence management application 200 may also search for individual image files stored in either one or all of database 180, archive 190, and the temporary storage device. By selecting “search” button 718 in view 700 (FIG. 7A), a user may be presented with view 740 as shown in FIG. 7C. View 740 may include a data field 744 enabling users to input information for searching by, for example, citation number, citation date, status, subject or defendant name, officer name, agency employing officer, report number, case number, and other search criteria.

According to an embodiment of the invention, users with an appropriate level of access rights may either download an image file, have an image file e-mailed to an Internet address, or output an image file from the temporary storage device, database 180, or archive 190 in any known or suitable output format (e.g., to a CD-ROM, DVD, floppy disk, or other media) for further processing or analysis. These image files may comprise original, un-edited image files, and/or redacted or edited image files.

The various views described above (e.g., FIGS. 7A-7C) and the features illustrated therein may differ with varying embodiments and should thus not be viewed as limiting.

Evidence management application 200 may also, via security module 210 and administration module 220, monitor the activity of users accessing evidence management application 200 to determine which image files were created, uploaded to server 160, searched, viewed, edited, downloaded or otherwise output, for further security purposes.

Such capabilities enable authorized users to have quick and easy access to video evidence while alleviating the drawbacks associated with current video evidence management systems.

Processing

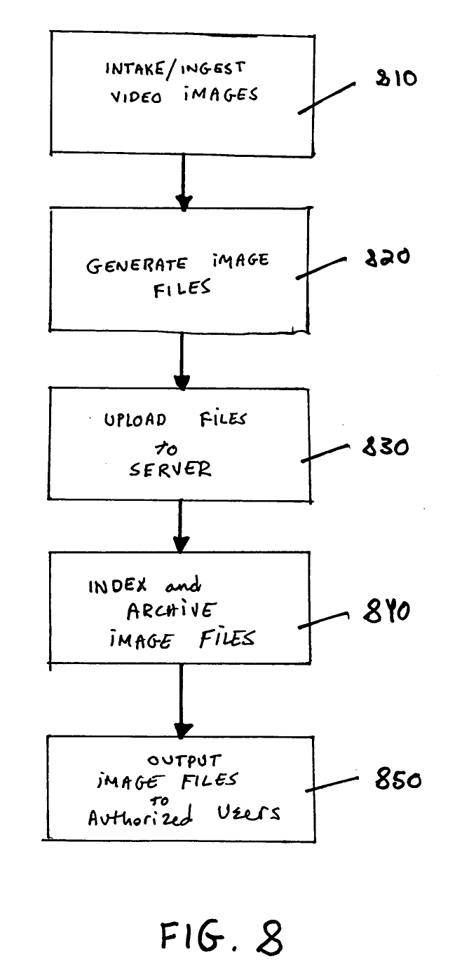

In addition to the foregoing description, FIG. 8 illustrates a flowchart of processing for storing, retrieving, manipulating, and otherwise managing video images having potential evidentiary significance, according to the invention, in one regard. The following operations may be accomplished using all or some of the of the system components described in detail above, and may incorporate all of the features and functionality of the invention as set forth in the foregoing description and accompanying drawing figures.

In an operation 810, a video image intake station may collect (or intake/ingest) video images captured by a video image capture device. Video image capture device may comprise, for example, a digital video image capture device, an analog video image capture device, a digital still camera with video burst capability, or any other known device capable of capturing a video image.

Video image intake station may comprise hardware to process the video images regardless of the format (or recording medium) of the video image capture device used to capture the video images. Examples of supported formats may include, but are not limited to, VHS, VHS-C, 8 mm, Hi8, Digital 8, and DV.

In an operation 820, the video images may be parsed into individual video image files. This process may be employed to select sequences of video images for indexing, archiving, and potential presentation (described below). In a preferred embodiment, the image files generated may be saved in a digital format.

In an operation 830, each of the individual image files may be uploaded to a server. The server may host an evidence management application which may comprise an Internet web site, an intranet site, or other host site or application maintained by a service provider, or other entity.

According to an embodiment of the invention, the uploaded image files may, in an operation 840, be stored on a temporary storage device and/or indexed and stored in a searchable database. For preservation purposes, a back-up copy of each image file may also be made and stored in an archive in any number of formats (e.g., DVD-RAM, DVD-R, etc.).

In an operation 850, individual image files may be searched and accessed by users who have been granted appropriate access rights. Users with an appropriate level of access rights may either download an image file, have an image file e-mailed to an Internet address, or output an image file in any known or suitable output format (e.g., to a CD-ROM, DVD, floppy disk, or other media) for further processing or analysis. These image files may comprise original, un-edited image files, and/or redacted or edited image files. These image files may also include one or more still images generated or otherwise rendered from the image file for printing for example, “wanted posters.”

### Alternative Embodiments

Other embodiments, uses and advantages of the invention will be apparent to those skilled in the art from consideration of the specification and practice of the invention disclosed herein.

For illustrative purposes, many of the embodiments of the invention were described above within the context of an evidence management application utilized by law enforcement agencies to organize and store video images captured by police video cameras. It should be recognized that the features and functionality of the invention may also be utilized in any number of fields or disciplines wherein a considerable volume of video images are captured and stored for further processing and analysis. Captured video images of (or relating to) a bank, casino, convenience store, retail establishment, hospital, personal residence, housing complex, highway system, public bus, subway system, airport, boarder crossing, personal residence, and crime scene, for example, are all video images that may be processed according to the system and method of the invention as disclosed herein.

Accordingly, the specification should be considered exemplary only.

What is claimed is:

1. A system for managing a plurality of video images for evidentiary purposes comprising:
a video intake station including at least one video image intake device that receives the plurality of video images, wherein said video intake station converts the received plurality of video images into a plurality of video image files;
a video archive that receives the plurality of video files and that creates an archival copy of the plurality of video images;
a video storage device that receives the plurality of video files and that stores the plurality of video files for a predetermined time; and
a searchable database that includes metadata for at least one of the plurality of video image files, wherein the metadata includes indicia that identifies said at least one of the plurality of video image files as legal evidence.

2. The system of claim 1, wherein said video intake station converts the received plurality of video images from analog signals to digital signals.

3. The system of claim 1, wherein said video intake station converts the received plurality of video images into a plurality of video image files each having at least one of a predetermined duration and a predetermined size.

4. The system of claim 1, wherein said video intake station converts the received plurality of video images into a plurality of video image files each corresponding to a particular incident.

5. The system of claim 1, wherein said video intake station further comprises a user interface that receives information from a user to be included as metadata for one or more of plurality of video image files.

6. The system of claim 1, wherein the at least one video image intake device receives the plurality of video images as signals directly from a video capture device.

7. The system of claim 6, wherein the at least one video image intake device receives the plurality of video images as wireless signals directly from the video capture device.

8. The system of claim 1, wherein the at least one video image intake device receives the plurality of video images as signals stored on a storage medium.

9. The system of claim 8, wherein the storage medium comprises a memory stick.

10. The system of claim 8, wherein the storage medium comprises a video tape.

11. The system of claim 8, wherein the video tape comprises at least one of an analog video tape and a digital video tape.

12. The system of claim 10, wherein the video tape comprises at least one of a VHS video tape and an 8 mm video tape.

13. The system of claim 1, wherein said video archive creates the archival copy of the plurality of video images on a DVD.

14. The system of claim 1, wherein said video archive secures the archival copy of the plurality of video images.

15. The system of claim 14, wherein said video archive encrypts the archival copy of the plurality of video images.

16. The system of claim 14, wherein said video archive prevents the archival copy of the plurality of video images from being altered.

17. The system of claim 14, wherein the archival copy of the plurality of video images is at least one of date stamped and time stamped.

18. The system of claim 1, wherein the plurality of video files on said video storage device are modified by a user.

19. The system of claim 18, wherein said searchable database includes information regarding any modifications made by the user.

20. The system of claim 1, wherein said searchable database includes information regarding access of at least one of the plurality of video images.

21. The system of claim 20, wherein said information includes at least one of a user identifier, a date, and a time.

22. The system of claim 4, wherein said video intake station automatically converts the received plurality of video images into a plurality of video image files.

23. The system of claim 3, wherein said video intake station automatically converts the received plurality of video images into a plurality of video image files.

24. The system of claim 23, wherein the received plurality of video images correspond to a plurality of incidents and wherein said video intake station automatically parses each of the plurality of incidents into a corresponding video image file.

25. The system of claim 24, wherein each of the plurality of incidents corresponds to a traffic stop.

26. A system for managing a plurality of video images for evidentiary purposes comprising:
a server for storing a plurality of video image files, each video image file corresponding to a piece of evidence;
a searchable database including metadata associated with each of the plurality of video image files; and
a user interface that provides one or more users with access to the plurality of video image files;
wherein the metadata associated with at least one of the plurality of video image files includes information regarding access by the one or more users of the at least one of the plurality of video image files.

27. The system of claim 26, wherein the information includes at least one of a user identifier, a nature of the access, a date, and a time.

28. The system of claim 26, wherein the metadata associated with each of the plurality of video image files includes an identifier associated with an archive copy of said each of the plurality of video image files.

29. The system of claim 26, wherein the metadata associated with at least one of the plurality of video image files includes an identifier associated with a legal proceeding for which the at least one of plurality of video image files includes evidence.

30. The system of claim 29, further comprising a user interface with which a user edits at least one of the plurality of video image files.

31. The system of claim 30, wherein the metadata associated with the edited video image file includes information regarding the edits.

32. The system of claim 26, further comprising a user interface with which a user searches said searchable database for at least one of the plurality of video image files using information associated with the at least one of the plurality of video image files.

33. The system of claim 32, wherein the information includes at least one of a police officer, a law enforcement agency, and a jurisdiction.

34. The system of claim 32, wherein the information includes at least one of a date associated with the piece of evidence and an identifier of a defendant.

35. The system of claim 26, wherein said user interface provides the user with access to the plurality of video image files in accordance with access rights associated with the user.

36. The system of claim 26, wherein said user interface provides the user with a thumbnail image associated with at least a portion of at least one of the plurality of video image files.

37. The system of claim 26, wherein said user interface provides the user with a plurality of thumbnail images associated with at least a portion of at least some of the plurality of video image files.

38. A method for managing video evidence comprising:
ingesting a plurality of video images from one or more media as a plurality of video image files at an intake station;
creating an archival copy of each of the plurality of video image files;
storing a non-archival copy of each of the plurality of video image files;
providing a user with access to at least one of the non-archival video image files; and
associating metadata with the at least one of the plurality of video image files, the metadata including a user identifier and a nature of the access.

39. The method of claim 38, wherein said ingesting a plurality of video images comprises copying digital video image files from the one or more media to a storage device at the intake station.

40. The method of claim 38, wherein said ingesting a plurality of video images comprises converting analog signals associated with the plurality of video images to digital signals.

41. The method of claim 38, wherein said ingesting a plurality of video images comprises:
parsing the plurality of video images into a plurality of video image files; and
storing the plurality of video image files on a storage device at the intake station.

42. The method of claim 41, wherein said parsing the plurality of video images comprises parsing the plurality of video images into a plurality of video image files each having at least one of a predetermined size and a predetermined duration.

43. The method of claim 41, wherein said parsing the plurality of video images comprises parsing the plurality of video images into a plurality of video image files each corresponding to a particular incident.

44. The method of claim 41, wherein said parsing the plurality of video images comprises parsing the plurality of video images into a plurality of video image files each corresponding to a particular scene.

45. The method of claim 38, further comprising receiving information from a user, said information to be included as metadata for one or more of the plurality of video image files.

46. The method of claim 38, wherein said ingesting a plurality of video images from one or more media comprises receiving the plurality of video images directly from a video capture device.

47. The method of claim 46, wherein said receiving the plurality of video images directly from a video capture device comprises receiving the plurality of video images as wireless signals directly from the video capture device.

48. The method of claim 38, wherein the one or more media includes a memory stick.

49. The method of claim 38, wherein the one or more media includes a video tape.

50. The method of claim 49, wherein the video tape comprises one of an analog video tape and a digital video tape.

51. The method of claim 49, wherein the video tape comprises one of an VHS video tape and an 8 mm video tape.

52. The method of claim 38, wherein said creating an archival copy of each of the plurality of video image files comprises creating a secure archival copy of each of the plurality of video image files.

53. The method of claim 52, wherein said creating a secure archival copy of each of the plurality of video image files comprises encrypting the archival copy of each of the plurality of video image files.

54. The method of claim 52, wherein said creating a secure archival copy of each of the plurality of video image files comprises computing a hash of the archival copy of each of the plurality of video image files.

55. The method of claim 38, wherein said creating an archival copy of each of the plurality of video image files comprises date stamping each of the plurality of video image files.

56. The method of claim 38, further comprising allowing the user to modify at least one video image file.

57. The method of claim 56, further comprising storing information associated with the modifications made by the user.

58. The method of claim 57, wherein the information includes at least one of a user identifier, a date, and a time.

59. The method of claim 38, wherein said ingesting a plurality of video images from one or more media comprises automatically ingesting the plurality of video images from one or more media as the plurality of video image files.

60. The method of claim 59, further comprising:
creating a thumbnail image from each of the plurality of video image files; and
presenting the thumbnail image to the user.

61. The method of claim 60, further comprising:
allowing the user to playback one of the video image files by selecting the thumbnail associated with the one of the video image files.

62. A method for managing video evidence comprising:
ingesting a plurality of video images from one or more media as a plurality of video image files at an intake station;
creating an archival copy of each of the plurality of video image files;
storing a non-archival copy of each of the plurality of video image files; and
in response to a user selecting one of the video image files, storing at least metadata associated with the selected video image file in a searchable database.

63. The method of claim 62, wherein said storing a non-archival copy of each of the plurality of video image files comprises storing a non-archival copy of each of the plurality of video image files for a predetermined period.

64. The method of claim 63, further comprising deleting the non-archival copy of each of the plurality of video images.

65. The method of claim 64, wherein said deleting the non-archival copy comprises deleting the non-archival copy after the predetermined period and prior to the user selecting the non-archival copy.

66. The method of claim 62, further in response to the user selecting one of the video image files, storing a working copy of the selected video image file.
